(19) United States
(12) Patent Application Publication
(10) Pub. No.: US 2004/0181506 A1
(43) Pub. Date: Sep. 16, 2004

(54) System and method for sorting bills of material

(76) Inventor: Sung-Jen Hsiang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/801,388

(22) Filed: Mar. 15, 2004

(30) Foreign Application Priority Data
Mar. 14, 2003 (TW) 92105711

(51) Int. Cl. G06F 7/00

(52) U.S. Cl. 707/1

(57) ABSTRACT

A BOM sorting system and method for sorting original BOMs is provided. The system comprises a database server (130), an original BOM file (1320), a part specification file (1340) and a BOM sorting module (1020), wherein the database server connects a plurality of designing computers (100) and a plurality of manufacturing computers (110). The original BOM file comprises a product name and information on parts for the product. The part specification file comprises assembly methods of the parts. The BOM sorting module is used for accessing the original BOM file and the part specification file, for sorting parts in the original BOM file, and for generating a plurality of sub-files, and for integrating the sub-files into an executable BOM file (1330). The method comprises the steps of: (a) accessing an original BOM file; (b) accessing a part specification file; (c) sorting parts in the original BOM file according to the part specification file; (d) generating a plurality of sub-files; and (e) integrating the sub-files into an executable BOM file.

### BACKGROUND OF THE INVENTION

1. Field of the Invention

The present invention relates to systems and methods for processing data by computer systems, and particularly to a bill of material (BOM) sorting system and method that provides sorting BOMs by computerized manufacturing management systems.

2. Background of the Invention

ORCAD is an application software widely used in circuit designing. The ORCAD runs in windows operation system and generates BOMs (Bills of Material) used in manufacturing management and inventory control. Normally, the generated BOMs of ORCAD are not fully fit for specified requirements of manufacturing systems. Therefore, operators manually sort the BOMs output by ORCAD and generate corresponding executable BOMs according to the manufacturing requirements. However, the manufacturing process needing manual sorting is costly and inefficient.

Information computerization may be used to solve this problem. The art of information computerization is disclosed in U.S. Pat. No. 5,630,070 entitled “Optimization of manufacturing resource planning.” The invention optimizes the manufacturing resource planning according to optimization algorithm and generates a matrix comprising a BOM and manufacturing limitations. The limitations comprise a constraint on the sum of products shipped, a constraint on inventory, and a constraint on available time for use of resources. However, no warning on shortage of parts is provided to operators. Furthermore, parts cannot be sorted and saved based on the manufacturing process.

Accordingly, it is desired to provide a BOM sorting system and method, which is able to not only sort and compare the BOM according to specified manufacturing requirement, but also provide operators up-dated information on manufacturing management and inventory control.

### SUMMARY OF THE INVENTION

A main objective of the present invention is to provide a BOM sorting system and method for sorting original BOM files and generating corresponding executable BOM files according to specified manufacturing requirements.

To accomplish the above objective, a BOM sorting system in accordance with a preferred embodiment of the present invention comprises an original BOM file, a part specification file, a BOM sorting module and a database server comprising the original BOM file and the part specification file. The database server is used for connecting a plurality of manufacturing computers and a plurality of designing computers. The original BOM file comprises a product name and information on parts for the product. The information on parts comprises columns for: “item,” “quantity,” “reference,” “part” and “description.” The columns respectively mean: a part item name, amount of the part in the product, the part's position in the product, the part's specification, and a detailed description of the part. The part specification file is for storing information on suppliers, vendors, manufacturing management and inventory control, and assembly methods. The assembly methods are surface mount device (SMD), pin through hole (PTH), and empty. The BOM sorting module is used for accessing the original BOM file and the part specification file, for sorting parts in the original BOM file, and for converting the original BOM file into the executable BOM file.

Further, the present invention provides a BOM sorting method comprising the steps of: (a) accessing an original BOM file; (b) accessing a part specification file; (c) sorting parts in the original BOM file according to the part specification file; (d) generating a plurality of sub-files; and (e) integrating all the sub-files into an executable BOM file.

The executable BOM file generated by the present invention is applicable to manufacturing management for scheduling work order and to inventory control for preparing materials.

Other objects, advantages and novel features of the present invention will be drawn from the following detailed description of the present invention with the attached drawings, in which:

### BRIEF DESCRIPTION OF THE DRAWINGS

FIG. 1 is a schematic diagram of an application environment of a BOM sorting system in accordance with a preferred embodiment of the present invention;

FIG. 2 is a block diagram of software infrastructure of a database server and a designing computer of the system of FIG. 1, showing only one designing computer thereof;

FIG. 3 is a schematic diagram of sub-files of an executable BOM file of the database server of the system shown in FIG. 2;

FIG. 4 is a block diagram of function sub-modules of a BOM sorting management module of the designing computer of the system of FIG. 2; and

FIG. 5 is a flowchart of operation of the BOM sorting system of FIG. 1.

### DETAILED DESCRIPTION OF THE INVENTION

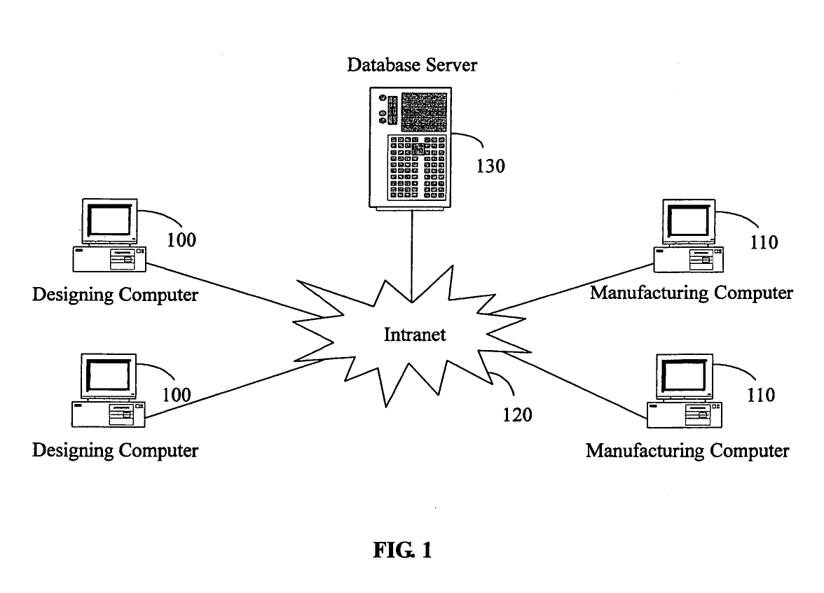

FIG. 1 is a schematic diagram of hardware configuration of a BOM (Bill of Material) sorting system in accordance with the preferred embodiment of the present invention. The BOM sorting system comprises a database server 130, and a plurality of designing computers 100 and a plurality of manufacturing computers 110 connected with the database server 130 through an Intranet 120. The database server 130 is for storing data of an organization, and for accessing and maintaining files in the database server 130. Furthermore, the database server 130 can update and search large amounts of data quickly. The designing computers 100 are located at different places in the organization; and are used for implementing the BOM sorting system of the present invention, for maintaining files in the database, and for outputting corresponding results. The manufacturing computers 110 are used for maintaining files in the database server 130, and for obtaining the results by accessing the database server 130. The manufacturing computers 110 may each be a suitable input/output device known in the art.

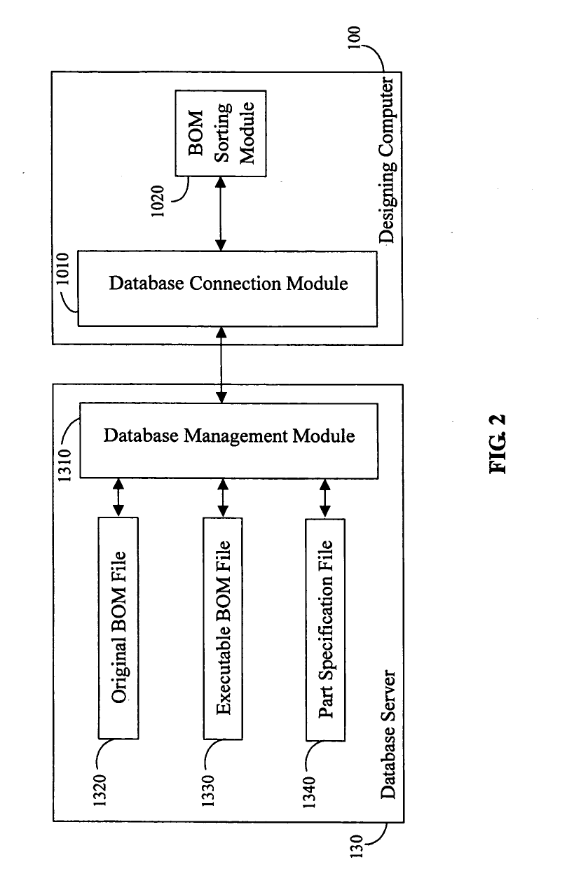

FIG. 2 is a block diagram of main function modules of the database server 130 and one of the designing computers 100. Each designing computer 100 comprises a BOM sorting module 1020 and a database connection module 1010. The database server 130 comprises a database management module 1310, an original BOM file 1320, an executable BOM file 1330, and a part specification file 1340. The BOM is a detailed bill of materials needed for manufacturing a product. In the preferred embodiment, the product is an electronic product such as a motherboard, and the materials comprise electronic components attached on the motherboard. The BOM comprises columns for: “product name,” “quantity,” and “reference.” “Reference” means a part's position in the product.

The original BOM file 1320 is used for storing BOMs. The BOMs are output by application software (e.g., ORCAD software) installed in the designing computer 100. The original BOM file 1320 comprises a product name and information on parts for the product. The information on parts comprises columns for: “item,” “quantity,” “reference,” “part” and “description.” The columns respectively mean: a part item name, amount of the part in the product, the part's position in the product, the part's specification, and a detailed description of the part. The executable BOM file 1330 is used for storing output of the BOM sorting system, especially for storing files in a format compatible with Microsoft Excel (hereinafter, “Excel compatible files”). The output is executable BOMs that satisfy manufacturing requirements. The part specification file 1340 is used for storing information on suppliers, vendors, manufacturing management and inventory control, and assembly methods. In the preferred embodiment, the assembly methods include SMD (Surface Mount Devices attached using SMT, Surface Mount Technology) and PTH (Pin Through Hole).

The BOM sorting module 1020 is used for sorting parts in the original BOM file 1320, and for converting the original BOM file 1320 into the executable BOM file 1330. The BOM sorting module 1020 sorts different parts into SMD parts, PTH parts, and empty parts according to assembly methods or detailed descriptions in the part specification 1340. Empty parts means parts which cannot be categorized as either SMD parts or PTH parts. Usually, this is because a particular part has been reserved, in that its position on the motherboard has not yet been finally determined, and/or its mode of attachment to the motherboard has not yet been finally determined. The BOM sorting module 1020 converts the original BOM file 1320 into an Excel compatible file, obtains information on suppliers, vendors, manufacturing management and inventory control by accessing the part specification file 1340, adds said information into the Excel compatible file, and thereby creates the executable BOM file 1330. The BOM sorting module 1020 accesses the files in the database server 130 through the database connection module 1010 and the database management module 1310. These files comprise the original BOM file 1320, the executable BOM file 1330, and the part specification file 1340.

The database connection module 1010 is used for connecting the BOM sorting module 1020 in the designing computer 100 and data in the database server 130. The BOM sorting module 1020 accesses data in various databases via the database connection module 1010. The database connection module 1010 may be Open Database Connectivity (ODBC).

The database management module 1310 is used for managing the original BOM file 1320, the executable BOM file 1330 and the part specification file 1340, and for creating, adding, deleting, updating and inquiring of records in said files stored in the database server 130. All the files in the database server 130 are input by the designing computers 100 or the manufacturing computers 110 as Excel compatible files via the database connection module 1010, and are managed by the database management module 1310.

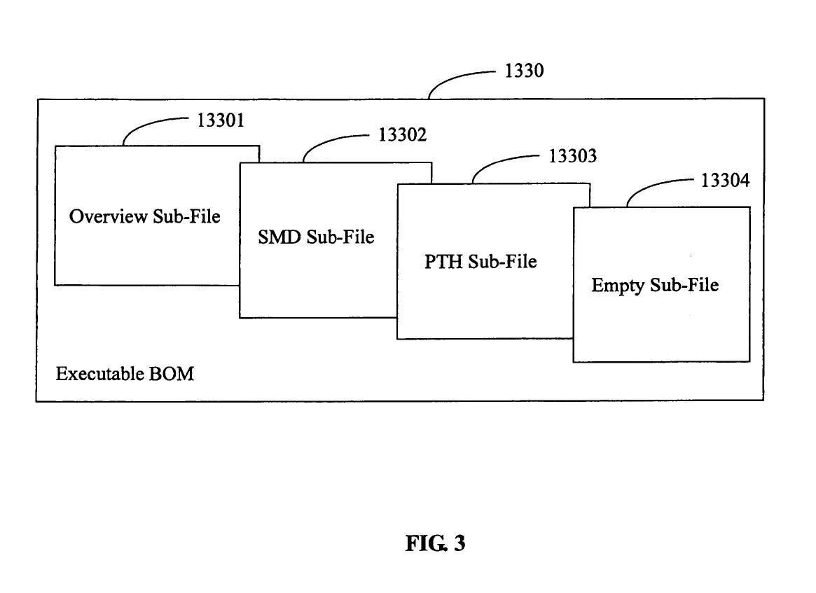

FIG. 3 is a schematic diagram illustrating sub-files in the executable BOM file 1330 of the database server 130. The executable BOM file 1330 is used for storing the output of the BOM sorting system, especially the Excel compatible files. The executable BOM file 1330 comprises an overview sub-file 13301, an SMD sub-file 13302, a PTH sub-file 13303, and an empty sub-file 13304. All the sub-files 13301-13304 appear in the form of Excel sheets, and each sub-file 13301-13304 comprises columns for: “product name,” “item,” “quantity,” “method,” “reference,” “part,” “description,” “vendor” and “supplier.” The overview sub-file 13301 is used for recording data on all parts, after conversion of the original BOM file 1320 according to the part specification file 1340. After sorting the original BOM file 1320 according to the part specification file 1340, the SMD sub-file 13302 records data on SMD parts; the PTH sub-file 13303 records data on PTH parts; and the empty sub-file 13304 records data on empty parts. In the empty sub-file 13304, the “description” column always has “empty” input therein.

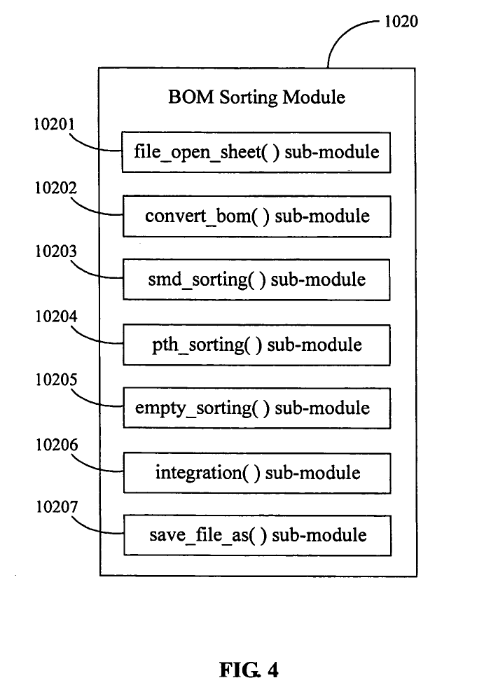

FIG. 4 is a block diagram illustrating function sub-modules of the BOM sorting module 1020 of each designing computer 100. The BOM sorting module 1020 comprises: a file_open_sheet( ) sub-module 10201 for inputting the original BOM file 1320; a convert_bom( ) sub-module 10202 for adding information on manufacturing management and inventory control, and for generating the overview sub-file 13301; an smd_sorting( ) sub-module 10203 for sorting SMD parts, and for generating the SMD sub-file 13302; a pth_sorting( ) sub-module 10204 for sorting PTH parts, and for generating the PTH sub-file 13303; an empty_sorting( ) sub-module 10205 for sorting empty parts, and for generating the empty sub-file 13304; an integration( ) sub-module 10206 for integrating all the sub-files into an Excel file, and for sorting the Excel file according to the “item” column; and a save_file_as( ) sub-module 10207 for storing the integrated Excel file, and for generating the executable BOM file 1330.

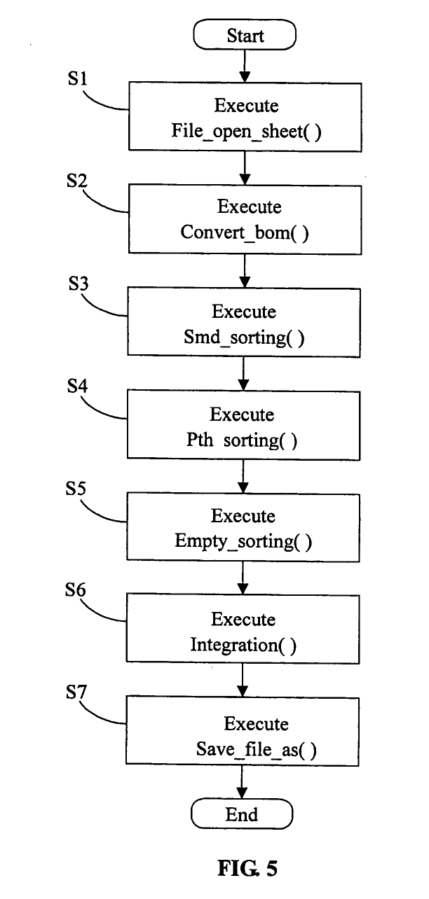

FIG. 5 is a flowchart of a preferred BOM sorting method of the present invention. In step S1, the file_open_sheet( ) sub-module 10201 obtains the original BOM file 1320 by accessing the database server 130. In step S2, the convert_bom( ) sub-module 10202 converts the original BOM file 1320 into the overview sub-file 13301 according to the part specification file 1340. First, the convert_bom( ) sub-module 10202 converts the original BOM file 1320 into an Excel sheet, and records a content of the obtained original BOM file 1320 in corresponding columns of the Excel sheet. Said content corresponds to the columns called: “product name,” “item,” “quantity,” “reference,” “part,” and “description.” Second, the convert_bom( ) sub-module 10202 obtains the part specification file 1340 by accessing the database server 130. A content of the obtained part specification file 1340 comprises information on assembly methods, suppliers, vendors, and manufacturing management and inventory control. Third, the convert_bom( ) sub-module 10202 adds new columns for “method,” “vendor” and “supplier” in the Excel sheet. These new columns record information respectively on the part's assembly method, the provider, and the agent. Fourth, the convert_bom( ) sub-module 10202 inputs “empty” or information on manufacturing management and inventory control in the “description” column. Fifth, the convert_bom( ) sub-module 10202 records the Excel sheet as an overview sub-file 13301.

In step S3, the smd_sorting( ) sub-module 10203 determines assembly methods of parts in the overview sub-file 13301 based on the contents of the “method” column, and records data on those parts whose assembly methods are SMD in the SMD sub-file 13302. In step S4, the pth_sorting( ) sub-module 10204 determines assembly methods of parts in the overview sub-file 13301 based on the contents of the “method” column, and records data on those parts whose assembly methods are PTH in the PTH sub-file 13303. In step S5, the empty_sorting( ) sub-module 10205 determines the detailed description of the parts in the overview sub-file 13301 based on contents of the “description” column, and records data on those parts whose descriptions are empty in the empty sub-file 13304. In step S6, the integration( ) sub-module 10206 integrates the above-described sub-files into an Excel compatible file; that is, the executable BOM file 1330. In other words, the executable BOM file 1330 comprises the overview sub-file 13301, the SMD sub-file 13302, the PTH sub-file 13303, and the empty sub-file 13304. In step S7, the save_file_as( ) sub-module 10207 saves the executable BOM file 1330 by accessing the database server 130.

In general, the BOM sorting system and method of the present invention may take forms other than what is described above. While preferred embodiments for carrying out the present invention have been described in detail, those familiar with the art to which the invention relates will recognize various alternative designs and embodiments for practicing the present invention. These alternative embodiments are within the scope of the present invention, which is defined by the claims appended hereto and allowable equivalents thereof.

What is claimed is:

1. A bill of material (BOM) sorting system for sorting original BOMs, the system comprising:
a database server comprising an original BOM file which comprises information on parts for a product and a part specification file which comprises assembly methods of the parts; and
a BOM sorting module for accessing the original BOM file and the part specification file, for sorting parts in the original BOM file according to the part specification file, for generating a plurality of sub-files, and for integrating all the sub-files into an executable BOM file.

2. The BOM sorting system according to claim 1, wherein the BOM sorting module is installed in each of a plurality of designing computers.

3. The BOM sorting system according to claim 1, wherein the information on the parts comprise a part item name, amount of the part in the product, the part's position in the product, the part's specification, and a detailed description of the part.

4. The BOM sorting system according to claim 1, wherein the data on the assembly methods of the parts comprise information on surface mount devices (SMD), pin through hole (PTH) and empty.

5. The BOM sorting system according to claim 1, wherein the sub-files comprise an SMD sub-file, a PTH sub-file and an empty sub-file corresponding to different assembly methods.

6. The BOM sorting system according to claim 1, further comprising a database connection module for connecting the BOM sorting module with the files in the database server, wherein the files comprises the part specification file, the original BOM file and the executable BOM file.

7. The BOM sorting system according to claim 1, wherein the database server comprises a database management module for managing the part specification file, the original BOM file and the executable BOM file, and for creating, adding, deleting, updating and inquiring records in said files.

8. A bill of material (BOM) sorting method for sorting original bills of material (BOMs), the method comprising the steps of:
accessing an original BOM file and a part specification file;
sorting parts in the original BOM file according to the part specification file;
generating a plurality of sub-files; and
integrating all the sub-files into an executable BOM file.

9. The BOM sorting method according to claim 8, wherein the part specification file comprises assembly methods of parts.

10. The BOM sorting method according to claim 9, wherein the assembly methods comprise surface mount devices (SMD), pin through hole (PTH) and empty.

11. The BOM sorting method according to claim 8, wherein the sub-files comprise an SMD sub-file, a PTH sub-file and an empty sub-file.

12. A method of sorting bill of material (BOM), comprising: providing a database server comprising an original BOM file, an executable BOM file and a part specification file; and
using a BOM sorting module to connect the database server via a database connection module and a database management module, so as to integrate plural sub-files in said executable file, wherein said sub-files are generated by sorting parts in the original BOM file according to the part specification file.
